(19) United States
(12) Patent Application Publication
(10) Pub. No.: US 2024/0231134 A1
(43) Pub. Date: Jul. 11, 2024

(54) OPTICAL WAVEGUIDE ELEMENT, AND OPTICAL MODULATION DEVICE AND OPTICAL TRANSMISSION APPARATUS WHICH USE SAME

(71) Applicant: SUMITOMO OSAKA CEMENT CO., LTD., Tokyo (JP)

(72) Inventors: Shoutarou HIRATA, Tokyo (JP); Shingo TAKANO, Tokyo (JP)

(73) Assignee: SUMITOMO OSAKA CEMENT CO., LTD., Tokyo (JP)

(21) Appl. No.: 18/281,107

(22) PCT Filed: Sep. 30, 2021
(86) PCT No.: PCT/JP2021/036277

§ 371 Date: Sep. 8, 2023

(51) Int. Cl. G02F 1/035; G02F 1/03

(52) U.S. Cl. CPC G02F 1/0356; G02F 1/0311; G02F 1/0327; G02F 2201/063

(57) ABSTRACT

An object is to provide an optical waveguide device including a dielectric layer covering an optical waveguide, in which occurrence of a problem such as peeling or cracking of the dielectric layer is suppressed. An optical waveguide device of the present invention includes an optical waveguide 2 formed on a substrate 1, and a dielectric layer IL covering the optical waveguide, in which the optical waveguide 2 is a rib type optical waveguide, and at least a part of a side surface of the rib type optical waveguide along a longitudinal direction has a slope shape formed with a curved surface (R6).

### TECHNICAL FIELD

The present invention relates to an optical waveguide device, and an optical modulation device and an optical transmission apparatus using the same, and particularly to an optical waveguide device including an optical waveguide formed on a substrate and a dielectric layer covering the optical waveguide.

### BACKGROUND ART

In the field of optical measurement technology or in the field of optical communication technology, optical waveguide devices such as an optical modulator using a substrate having an electro-optic effect have been widely used. Particularly, in accordance with an increase in information communication amount in recent years, a high frequency and a large capacity of optical communication used between cities or between data centers at a long distance have been desired. In addition, a high frequency and size reduction of the optical modulator are required because of a restricted space of a base station.

In achieving size reduction of the optical modulator, narrowing a width of the optical waveguide to form a micro optical waveguide can increase a confining effect of light. Consequently, a bending radius of the optical waveguide is decreased, and size reduction can be achieved. For example, lithium niobate (LN) having an electro-optic effect has small distortion and a small optical loss in converting an electrical signal into an optical signal and thus, is used as a long-distance optical modulator. In the optical waveguide of the LN optical modulator in the related art, a mode field diameter (MFD) is approximately 10 μm, and the bending radius of the optical waveguide is several tens of mm which is large. Thus, it is difficult to achieve size reduction.

In recent years, substrate polishing techniques and substrate bonding techniques have been improved and enabled LN substrates to be achieved as thin plates, and the MFD of the optical waveguide has also been studied and developed to be 3 μm or lower and approximately 1 μm. Since decreasing the MFD increases the confining effect of light, the bending radius of the optical waveguide can be further decreased.

As the width or a height of the optical waveguide is decreased, roughness of a surface of the optical waveguide significantly affects an optical loss of a light wave propagating through the optical waveguide. For example, in the case of forming a protruding optical waveguide (referred to as a rib type optical waveguide), surface degradation caused by fine roughness is likely to occur on a side surface of a protruding portion depending on an etching speed or on an etching temperature.

In order to eliminate such a problem, Patent Literature No. 1 suggests providing a dielectric layer (insulating film) that covers the optical waveguide.

Meanwhile, in the case of using a micro-optical waveguide having an MFD lower than 10 μmφ which is an MED of an optical fiber, directly joining an end portion (device end surface) of the optical waveguide provided in the optical waveguide device to the optical fiber causes a large insertion loss.

In order to eliminate such a problem, a spot size converter (SSC) is disposed in the end portion of the optical waveguide in Patent Literature No. 2. As an example of the SSC, configuring the SSC with a block body (dielectric film) covering the optical waveguide is suggested.

FIG. 1 is an example of an optical waveguide device disclosed in Patent Literature No. 3, in which a plurality of Mach-Zehnder type optical waveguides are integrated, and the SSC is provided. The optical waveguide device can also be used in a high bandwidth-coherent driver modulator (HB-CDM) and the like. In an optical waveguide part including a modulation portion MP that modulates the light wave by applying a modulation signal to an optical waveguide 2, a dielectric layer (insulating film) IL is disposed on the optical waveguide 2 as in Patent Literature No. 1. In addition, in a region indicated by the SSC, the block body (dielectric film) of the SSC is used as in Patent Literature No. 2. Lin denotes input light, and Lout denotes output light.

FIG. 2 is an enlarged plan view of a part corresponding to dotted line frame A in FIG. 1 and is a diagram illustrating an example of a configuration of a nearby part including the SSC. FIG. 3 illustrates a cross section view taken along dotted line C-C′ in FIG. 2, FIG. 4 illustrates a cross section view taken along dotted line B-B′ in FIG. 2, and FIG. 5 illustrates a cross section view taken along dotted line A-A′ in FIG. 2.

FIG. 3 is the same structure as the optical waveguide including the modulation portion MP in the optical waveguide device, and the rib type optical waveguide 2 is formed on a part of a substrate 1. The dielectric layer IL is disposed to cover a side surface and an upper surface of the optical waveguide 2. Since the substrate 1 and the 10 optical waveguide 2 are very thin layers, a reinforcing substrate 3 is disposed on a lower surface side of the substrate 1 to increase mechanical strength.

As illustrated in FIG. 2, widths of the optical waveguide 2 and the substrate 1 have a tapered shape that is gradually narrowed toward an end portion of the substrate. Thus, while the rib type optical waveguide 2 functions as a core part of the optical waveguide in FIG. 3, the rib type optical waveguide 2 and the substrate 1 serve as the core part in FIG. 4. Furthermore, in FIG. 5, the dielectric layer IL also serves as the core part, and the MED of the optical waveguide is gradually increased. Since the MFD can be decreased by narrowing a width of the dielectric layer, the MFD can be controlled to a target size, and the optical insertion loss with respect to the optical fiber and the like can be reduced.

As the cross section shape changes from FIG. 3 to FIG. 5, the width of the dielectric layer IL is narrowed, and a size of a cross section area (surface area) occupied by the rib type optical waveguide 2 and by the substrate 1 is also decreased at the same time. Generally, as the width of the dielectric layer IL is narrowed, a close contact between the dielectric layer IL and the substrate 1 (optical waveguide 2) and a close contact between the dielectric layer IL and the reinforcing substrate 3 are decreased, and a phenomenon such as peeling or cracking of the dielectric layer IL also occurs. This phenomenon is noticeable particularly in a part in which the width of the substrate 1 (optical waveguide 2) or of the dielectric layer IL is narrow as in the SSC or the like.

An example in which the substrate 1 and the optical waveguide 2 or the dielectric layer IL has a gradually narrowing width toward the end portion of the optical waveguide has been described in the above description. However, even in a case where the width is conversely gradually widened, the problem such as peeling also occurs in a case where the width is narrow.

### CITATION LIST

### Patent Literature

[Patent Literature No. 1]: Japanese Patent Application No. 2021-050409 (filing date: Mar. 24, 2021)
[Patent Literature No. 2] Japanese Patent Application No. 2020-165004 (filing date: Sep. 30, 2020)
[Patent Literature No. 3] PCT/JP2021/032007 (filing date: Aug. 31, 2021)

### SUMMARY OF INVENTION

### Technical Problem

An object to be solved by the present invention is to solve the above problem and to provide an optical waveguide device including a dielectric layer covering an optical waveguide, in which occurrence of a problem such as peeling or cracking of the dielectric layer is suppressed. Furthermore, an optical modulation device and an optical transmission apparatus using the optical waveguide device are provided.

### Solution to Problem

In order to solve the object, an optical waveguide device of the present invention, and an optical modulation device and an optical transmission apparatus using the same have the following technical features.

(1) An optical waveguide device includes an optical waveguide formed on a substrate, and a dielectric layer covering the optical waveguide, in which the optical waveguide is a rib type optical waveguide, and at least a part of a side surface of the rib type optical waveguide along a longitudinal direction has a slope shape formed with a curved surface.

(2) In the optical waveguide device according to (1), a shape of a cross section perpendicular to a propagation direction of a light wave of the rib type optical waveguide is a trapezoidal shape, a triangular shape, or a shape of a stack of a plurality of tiers, and at least a part of an edge extending in a horizontal direction is formed with a curve.

(3) The optical waveguide device according to (1) or (2) further includes a spot size converter including the rib type optical waveguide and the dielectric layer, in which in the spot size converter, a width of the rib type optical waveguide is decreased or increased toward an end portion of the substrate, and the dielectric layer functions as the optical waveguide.

(4) The optical waveguide device according to any one of (1) to (3) further includes a spot size converter including the rib type optical waveguide and the dielectric layer, in which in the spot size converter, a thickness of the rib type optical waveguide is decreased or increased toward an end portion of the substrate, and the dielectric layer functions as the optical waveguide.

(5) In the optical waveguide device according to any one of (1) to (4), a refractive index of the dielectric layer is lower than a refractive index of the rib type optical waveguide.

(6) An optical modulation device includes the optical waveguide device according to any one of (1) to (5), a case accommodating the optical waveguide device, and an optical fiber through which a light wave is input into the optical waveguide or output from the optical waveguide.

(7) In the optical modulation device according to (6), the optical waveguide device includes a modulation electrode for modulating a light wave propagating through the optical waveguide, and an electronic circuit that amplifies a modulation signal to be input into the modulation electrode of the optical waveguide device is provided inside the case.

(8) An optical transmission apparatus includes the optical modulation device according to (6) or (7), and an electronic circuit that outputs a modulation signal causing the optical modulation device to perform a modulation operation.

### Advantageous Effects of Invention

In the present invention, an optical waveguide device includes an optical waveguide formed on a substrate, and a dielectric layer covering the optical waveguide, in which the optical waveguide is a rib type optical waveguide, and at least a part of a side surface of the rib type optical waveguide along a longitudinal direction has a slope shape formed with a curved surface. Thus, an area of contact between the dielectric layer and the rib type optical waveguide can be further increased, and it is possible to increase a close contact between both of the dielectric layer and the rib type optical waveguide and to suppress occurrence of a problem such as peeling or cracking of the dielectric layer.

### BRIEF DESCRIPTION OF DRAWINGS

FIG. 1 is a plan view illustrating an example of an optical waveguide device that is disclosed in Patent Literature No. 3 and that includes a dielectric layer covering an optical waveguide.

FIG. 2 is an enlarged plan view of a part corresponding to dotted line frame A in FIG. 1.

FIG. 3 is a cross section view taken along dotted line C-C′ in FIG. 2.

FIG. 4 is a cross section view taken along dotted line B-B′ in FIG. 2.

FIG. 5 is a cross section view taken along dotted line A-A′ in FIG. 2.

FIG. 6 is a cross section view taken along dotted line A-A′ in FIG. 2 and is a diagram illustrating a first example according to the present invention.

FIG. 7 is a cross section view taken along dotted line A-A′ in FIG. 2 and is a diagram illustrating a second example according to the present invention.

FIG. 8 is a cross section view taken along dotted line B-B′ in FIG. 2 and is a diagram illustrating a third example according to the present invention.

FIG. 9 is a cross section view taken along dotted line B-B′ in FIG. 2 and is a diagram illustrating a fourth example according to the present invention.

FIG. 10 is a cross section view taken along dotted line C-C′ in FIG. 2 and is a diagram illustrating a fifth example according to the present invention.

FIG. 11 is a diagram illustrating an application example (sixth example) of an optical waveguide device of the present invention.

FIG. 12 is a diagram illustrating an application example (seventh example) of the optical waveguide device of the present invention.

FIG. 13 is a diagram illustrating an application example (eighth example) of the optical waveguide device of the present invention.

FIG. 14 is a plan view for describing an optical modulation device and an optical transmission apparatus of the present invention.

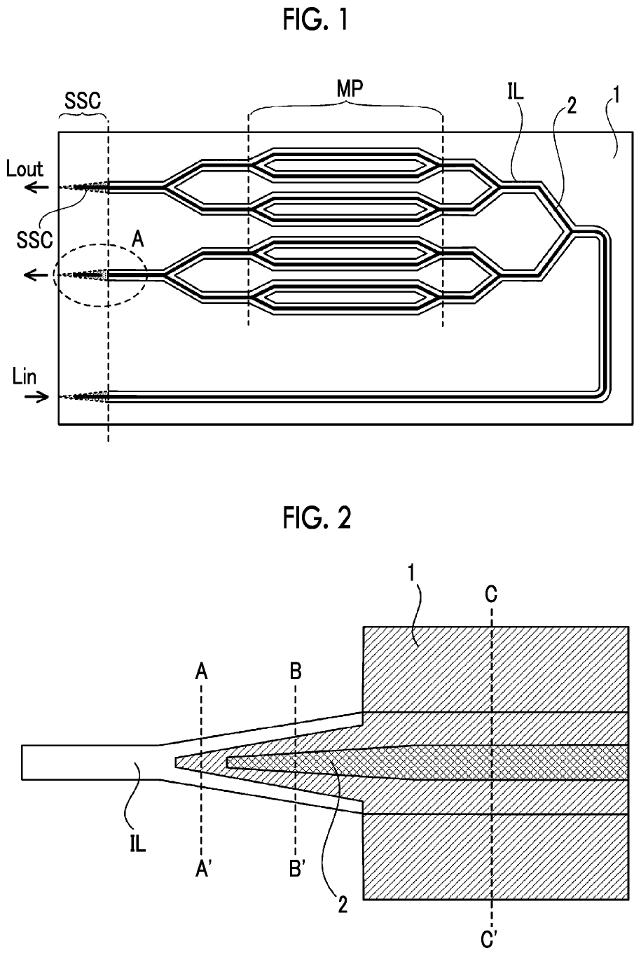

### DESCRIPTION OF EMBODIMENTS

Hereinafter, an optical waveguide device of the present invention will be described in detail using preferred examples.

As illustrated in FIGS. 6 to 13, the optical waveguide device of the present invention includes an optical waveguide 2 formed on a substrate 1, and a dielectric layer IL covering the optical waveguide, in which the optical waveguide 2 is a rib type optical waveguide, and at least a part of a side surface of the rib type optical waveguide along a longitudinal direction has a slope shape formed with a curved surface (R1 to R9).

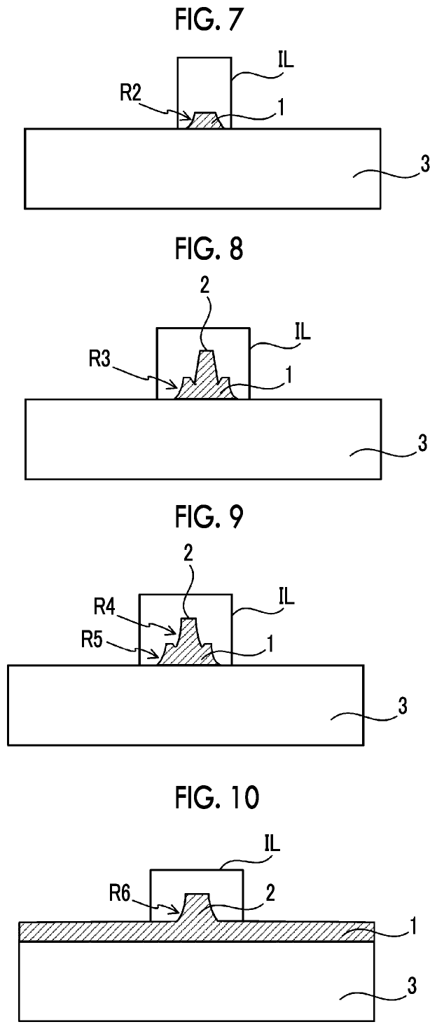

The “rib type optical waveguide” in the present invention means a part that has a protruding cross section shape as illustrated in FIGS. 6 to 13 and that functions as the optical waveguide, and is not only the part 2 protruding from the substrate 1 as in FIG. 10 and may include not only the protruding part 2 but also the substrate 1 inside an SSC or the like as illustrated in FIGS. 8 and 9. Furthermore, the “rib type optical waveguide” may be only the substrate 1 as in FIGS. 6 and 7. However, the “rib type optical waveguide” does not include the dielectric layer IL.

As the material 1 that has an electro-optic effect and that is used in the optical waveguide device of the present invention, substrates of lithium niobate (LN), lithium tantalate (LT), lead lanthanum zirconate titanate (PLZT), and the like or base materials obtained by doping these substrate materials with magnesium can be used. In addition, vapor-phase growth films and the like formed of these materials can be used.

In addition, various materials such as semiconductor materials or organic materials can also be used as the optical waveguide.

As a method of forming the optical waveguide 2, a rib type optical waveguide obtained by forming a part corresponding to the optical waveguide to have a protruding shape in the substrate by, for example, etching the substrate 1 other than the optical waveguide or by forming grooves on both sides of the optical waveguide can be used. Furthermore, a refractive index of a surface of the substrate can be further increased using a thermal diffusion method with Ti or the like, a proton exchange method, or the like in accordance with the rib type optical waveguide.

A thickness of the substrate (thin plate) 1 on which the optical waveguide 2 is formed is set to 10 μm or lower, more preferably 5 μm or lower, and still more preferably 1 μm or lower in order to achieve velocity matching between a microwave of a modulation signal and a light wave. In addition, a height of the rib type optical waveguide is set to 4 μm or lower, more preferably 3 μm or lower, and still more preferably 1 μm or lower or 0.4 μm or lower. In addition, it is also possible to form a vapor-phase growth film on a reinforcing substrate 3 and to process the film to have a shape of the optical waveguide.

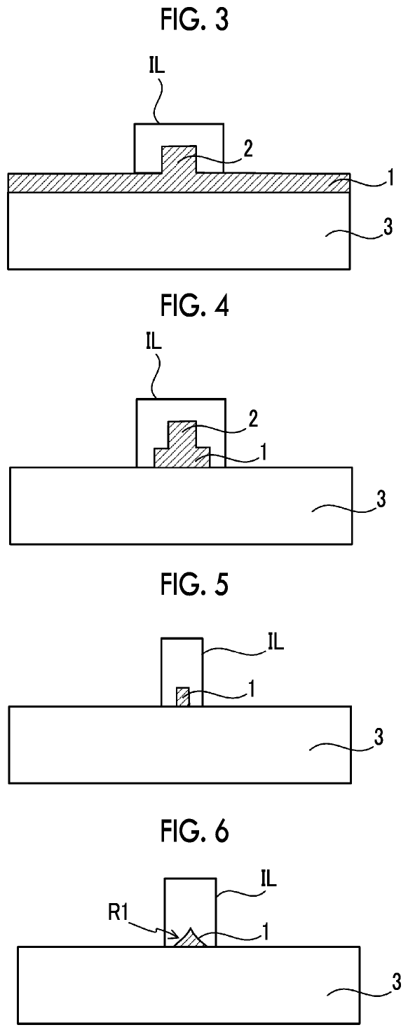

The substrate on which the optical waveguide is formed is adhesively fixed to the reinforcing substrate 3 via direct joining or through an adhesive layer of resin or the like as illustrated in FIGS. 3 to 10 in order to increase mechanical strength. As the reinforcing substrate 3 to be directly joined, a substrate including an oxide layer of a material such as crystal, glass, or the like that has a lower refractive index than the optical waveguide and than the substrate on which the optical waveguide is formed, and that has a similar coefficient of thermal expansion to the optical waveguide or the like is preferably used. Composite substrates obtained by forming a silicon oxide layer on a silicon substrate and by forming a silicon oxide layer on an LN substrate, which are abbreviated to SOI and LNOI, can also be used.

The optical waveguide 2 in FIG. 2 is covered with the dielectric layer (insulating film) IL shown in Patent Literature No. 1. As illustrated in FIG. 10, an upper surface and a side surface of the rib type optical waveguide 2 are covered with the dielectric layer IL.

The dielectric layer IL is preferably a dielectric body having a refractive index higher than 1 and is set to have a refractive index of 0.5 times or higher and 0.75 times or lower than the refractive index of the optical waveguide 2. A thickness of the dielectric layer IL is not particularly limited and can be formed up to a thickness of approximately 10 μm. In an optical waveguide part (except the SSC) including a modulation portion MP that modulates the light wave by applying a modulation signal to the optical waveguide 2, the optical waveguide 2 functions as a core portion, and the dielectric layer functions as a clad portion.

While the dielectric layer IL can be formed of an inorganic material such as SiO₂ using a sputtering method or a CVD method, an organic material such as resin may be used. As resin, a photoresist including a coupling agent (crosslinking agent) can be used, and a so-called photosensitive insulating film (permanent resist) that is cured by a crosslinking reaction developed by heat can be used. As resin, other materials such as polyamide-based resin, melamine-based resin, phenol-based resin, amino-based resin, and epoxy-based resin can also be used.

In FIG. 2, the dielectric layer IL is disposed across a space between the optical waveguide 2 (right side of the drawing) and the spot size converter SSC (left side of the drawing). The present invention is not limited to such an example, and different dielectric layers can also be used between the optical waveguide side and the SSC side. However, in a case where the dielectric layers have different refractive indices, a propagation loss of the light wave is likely to occur in a boundary part between the dielectric layers. Thus, it is desirable to set a difference in the refractive index between the dielectric layers in the boundary part to a predetermined value or lower, for example, 0.5 or lower. More preferably, the dielectric layer IL covering the optical waveguide contiguously enters from the modulation portion side of the optical waveguide into the spot size converter as a part of the dielectric layer constituting the spot size converter. Still more preferably, parts of the dielectric layer of the optical waveguide on the modulation portion side and of the dielectric layer constituting the spot size converter are formed at the same time using the same manufacturing process.

In the spot size converter SSC, the dielectric layer IL functions as a part of the optical waveguide, particularly as the core portion of the optical waveguide, together with the optical waveguide 2 and with the substrate 1.

As a width of the dielectric layer IL constituting the SSC in FIG. 2, the width is formed to have a tapered shape from the viewpoint of converting a mode diameter and of confining light. The width is approximately 5 μm at a position of the left end in FIG. 2. Meanwhile, in the modulation portion, the width of the dielectric layer IL is a width of 10 μm or higher from the viewpoint of a close contact or the like. Thus, a horizontal width of the dielectric layer IL is wider in the modulation portion than in the SSC.

While the widths of the optical waveguide (protruding part 2) and the substrate 1 are gradually changed in a tapered manner in FIG. 2, the present invention is not limited to the optical waveguide and the substrate 1 in FIG. 2. Thicknesses of the optical waveguide 2 and the substrate 1 may be gradually decreased or increased, or both may be combined with each other.

As illustrated in FIGS. 6 to 13, a feature of the optical waveguide device of the present invention is causing at least a part of the side surface of the rib type optical waveguide along the longitudinal direction to have the slope shape formed with the curved surface (R1 to R9). By providing such a curved surface (in a cross section view, a curve of a boundary line), an area of contact between the dielectric layer and the rib type optical waveguide is increased, and a close contact between both of the dielectric layer and the rib type optical waveguide can be increased.

In a first example in FIG. 6, the substrate 1 serves as the rib type optical waveguide, and the curved surface R1 is formed on the side surface of the rib type optical waveguide. The cross section shape of the rib type optical waveguide is an approximately triangular shape.

In addition, in a second example in FIG. 7, the cross section shape of the rib type optical waveguide (substrate 1) is an approximately trapezoidal shape. The curved surface R2 is formed on an edge (side edge) of the trapezoidal shape extending in a horizontal direction.

The cross section shape (a shape of a cross section perpendicular to a propagation direction of the light wave) of the rib type optical waveguide in the present invention may be a trapezoidal shape, a triangular shape, or a shape of a stack of a plurality of tiers, and at least a part of the edge extending in the horizontal direction may be formed with a curve.

A third example in FIG. 8 has a shape of stacked trapezoidal shapes, and the curved surface R3 is provided on a side surface of the lower trapezoidal shape. In a fourth example in FIG. 9, the curved surfaces R4 and R5 are formed on side surfaces of upper and lower trapezoidal shapes. While FIGS. 8 and 9 are cross sections taken along dotted line B-B′ in FIG. 2, such a shape of a stack of a plurality of tiers can also be formed in, for example, the substrate 1 taken along dotted line A-A′ or in the optical waveguide (protruding part 2) taken along dotted line C-C′.

In a fifth example in FIG. 10, the curved surface R6 is formed on a side surface of a trapezoidal shape of the protruding part 2 (rib type optical waveguide) formed on the substrate 1.

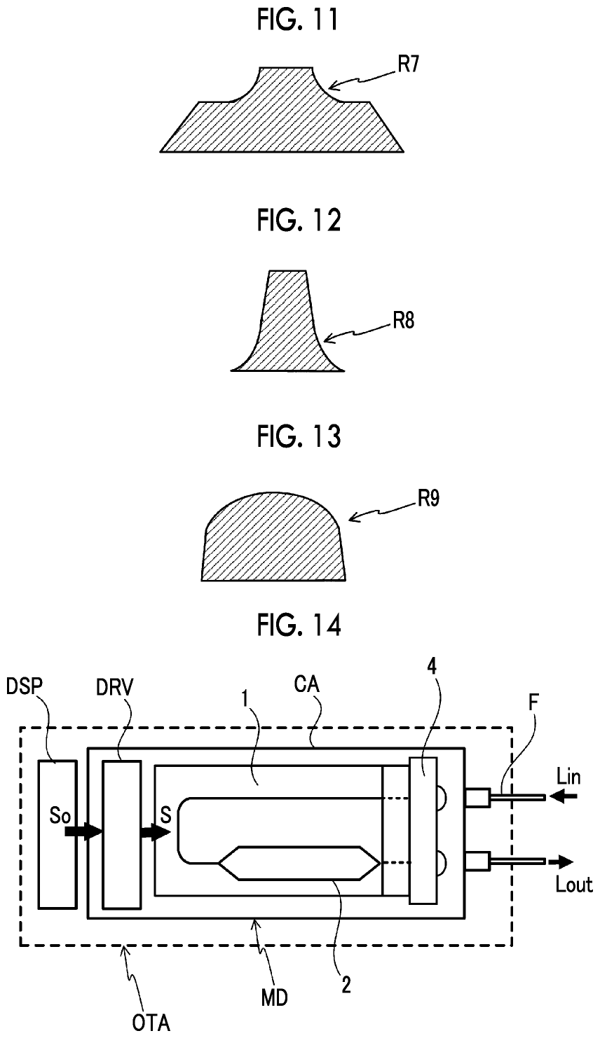

Furthermore, it is possible to form the curved surface R7 on a part of a plurality of tiers as illustrated in FIG. 11 or to form a part as a flat surface (a boundary in a cross section is a straight line) and form an other part as the curved surface R8 on the same side surface as illustrated in FIG. 12. It is also possible to form the curved surface R9 that bulges outside as illustrated in FIG. 13.

As a method of forming the curved surface as illustrated in FIGS. 6 to 13, it is possible to pattern a desired etching mask having the curved surface and to form the curved surface using a dry etching method such as reactive ion etching (RIE), a wet etching method using a suitable etching liquid, or the like.

In the optical waveguide device of the present invention, a modulation electrode that modulates the light wave propagating through the optical waveguide 2 is provided and is accommodated inside a case CA as illustrated in FIG. 14. Furthermore, an optical modulation device MD can be configured by providing an optical fiber (F) through which the light wave is input into the optical waveguide or output from the optical waveguide. In FIG. 14, the optical fiber F is optically coupled to the optical waveguide inside the optical waveguide device using an optical lens 4. The present invention is not limited to the optical fiber F in FIG. 14, and the optical fiber may be introduced into the case through a through-hole that penetrates through a side wall of the case, and be directly joined to the optical waveguide device.

An optical transmission apparatus OTA can be configured by connecting, to the optical modulation device MD, an electronic circuit (digital signal processor DSP) that outputs a modulation signal causing the optical modulation device MD to perform a modulation operation. The modulation signal to be applied to the optical waveguide device is required to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

### INDUSTRIAL APPLICABILITY

As described above, according to the present invention, it is possible to provide an optical waveguide device including a dielectric layer covering an optical waveguide, in which occurrence of a problem such as peeling or cracking of the dielectric layer is suppressed. Furthermore, an optical modulation device and an optical transmission apparatus using the optical waveguide device can be provided.

### REFERENCE SIGNS LIST

1: substrate (thin plate, film body) on which optical waveguide is formed
2: optical waveguide
IL: dielectric layer
MP: modulation portion
SSC: spot size converter

1. An optical waveguide device comprising:
an optical waveguide formed on a substrate; and
a dielectric layer covering the optical waveguide,
wherein the optical waveguide is a rib type optical waveguide, and at least a part of a side surface of the rib type optical waveguide along a longitudinal direction has a slope shape formed with a curved surface.

2. The optical waveguide device according to claim 1, wherein a shape of a cross section perpendicular to a propagation direction of a light wave of the rib type optical waveguide is a trapezoidal shape, a triangular shape, or a shape of a stack of a plurality of tiers, and at least a part of an edge extending in a horizontal direction is formed with a curve.

3. The optical waveguide device according to claim 1, further comprising: a spot size converter including the rib type optical waveguide and the dielectric layer, wherein in the spot size converter, a width of the rib type optical waveguide is decreased or increased toward an end portion of the substrate, and the dielectric layer functions as the optical waveguide.

4. The optical waveguide device according to claim 1, further comprising: a spot size converter including the rib type optical waveguide and the dielectric layer, wherein in the spot size converter, a thickness of the rib type optical waveguide is decreased or increased toward an end portion of the substrate, and the dielectric layer functions as the optical waveguide.

5. The optical waveguide device according to claim 1, wherein a refractive index of the dielectric layer is lower than a refractive index of the rib type optical waveguide.

6. An optical modulation device comprising:
the optical waveguide device according to any one of claims 1 to 5;
a case accommodating the optical waveguide device; and
an optical fiber through which a light wave is input into the optical waveguide or output from the optical waveguide.

7. The optical modulation device according to claim 6, wherein the optical waveguide device includes a modulation electrode for modulating a light wave propagating through the optical waveguide, and an electronic circuit that amplifies a modulation signal to be input into the modulation electrode of the optical waveguide device is provided inside the case.

8. An optical transmission apparatus comprising:
the optical modulation device according to claim 6; and
an electronic circuit that outputs a modulation signal causing the optical modulation device to perform a modulation operation.
